(19) United States
(12) Patent Application Publication
(10) Pub. No.: US 2025/0286471 A1
(43) Pub. Date: Sep. 11, 2025

(54) SINGLE-INPUT MULTI-OUTPUT RESONANT REGULATING RECTIFIER

(71) Applicant: KOREA UNIVERSITY RESEARCH AND BUSINESS FOUNDATION, Seoul (KR)

(72) Inventors: Hyung-Min LEE, Seoul (KR); Hyun-Su LEE, Seoul (KR)

(21) Appl. No.: 19/014,105

(22) Filed: Jan. 8, 2025

(30) Foreign Application Priority Data
Mar. 7, 2024 (KR) 10-2024-0032569

(51) Int. Cl. H02M 7/23; H02J 50/12; H02M 1/08; H02M 1/14

(52) U.S. Cl. CPC H02M 7/23; H02J 50/12; H02M 1/08; H02M 1/14

(57) ABSTRACT

Disclosed herein is a single-input multi-output resonant regulating rectifier. The single-input multi-output resonant regulating rectifier may include: a conversion circuit unit converting a wireless power alternating current (AC) signal into half-cycle input signals V_{INN} and V_{INP}; and an output generation circuit unit generating a plurality of outputs within a half cycle by generating a plurality of gate signals in a plurality of different regions within each half cycle based on the half-cycle input signal V_{INN} input through the conversion circuit unit.

### CROSS-REFERENCE TO RELATED APPLICATION

This application claims the benefit of priority under 35 U.S.C. § 119 (a) to Korean Patent Application No. 10-2024-0032569, filed on Mar. 7, 2024, the entire contents of which is incorporated herein by reference.

### BACKGROUND

### (a) Technical Field

The present disclosure relates to a single-input multi-output resonant regulating rectifier.

### (b) Background Art

Instead of a technology for supplying power to electronic devices through wires, a technology for supplying power through wireless power transfer (WPT) has emerged. A WPT system transmits and receives power through changes in magnetic field of coils at a transmitting end and a receive end. The receive end is composed of an alternating current (AC)-direct current (DC) rectifier and a DC-DC converter in a two-stage structure (see FIG. 1).

The AC-DC rectifier converts an AC voltage V_{INN} into a DC voltage V_{REC}. In this case, V_{REC} is not set to a targeted voltage value through feedback, but changes depending on a distance between the coils, an angle, and a load R_{L}. For this reason, a DC-DC converter is essentially required behind the AC-DC rectifier. Such a DC-DC converter converts an unstable DC voltage V_{REC} into a stable DC voltage V_{REG} through feedback. In addition, such a DC voltage V_{REG} may be adjusted according to a consumer/designer's goal, and it hardly changes depending on the distance between the coils, the angle, and the load R_{L}.

A system having such a two-stage structure has several disadvantages. Among them, a first disadvantage is that power conversion efficiency is low and a voltage conversion rate is low due to two structures. In addition, there is a disadvantage that a chip size is great due to the two-stage structure.

In order to solve such problems, a resonant regulating rectifier in which a two-stage structure is reduced to a one-stage structure has been proposed (see FIG. 2). In order to convert an AC voltage into a stable and targeted DC voltage with a one-stage structure, voltage pulse width modulation (PWM) has been applied as illustrated in FIG. 3.

FIG. 4 is a diagram illustrating three one-stage structures according to the related art. In FIG. 4, V_{REG1} represents a high voltage, and V_{REG2} represents a low voltage. A first structure of FIG. 4 is a method of generating a dual output by bundling several outputs, and a second structure of FIG. 4 is a method of generating one output when a cycle is +cycle and the other output when a cycle is a-cycle. A third structure of FIG. 4 is a method of using an intermediate voltage required to generate a high voltage (first output) in a voltage doubler structure as a second output.

Such a related art has a disadvantage that efficiency is low when generating the low voltage V_{REG2} because V_{SG} of P₄ is small, it is difficult for a comparator to find a point in time where V_{INN} and V_{REG2} coincide with each other when generating the low voltage V_{REG2}, an output voltage ripple is great, maximum output power is small, and the number of outputs is small.

### SUMMARY OF THE DISCLOSURE

The present disclosure is to provide a single-input multi-output resonant regulating rectifier.

In addition, the present disclosure is to provide a single-input multi-output resonant regulating rectifier capable of generating three outputs within a half cycle.

Further, the present disclosure is to provide a single-input multi-output resonant regulating rectifier having a low output voltage ripple and high maximum output power, and capable of selecting a multiple output mode.

Furthermore, the present disclosure is to provide a single-input multi-output resonant regulating rectifier capable of being applied to medical system on chips (SoCs) or artificial retinas requiring dynamic voltage scaling through three output modes.

According to an aspect of the present disclosure, there is provided a single-input multi-output resonant regulating rectifier.

According to an embodiment of the present disclosure, the single-input multi-output resonant regulating rectifier may include: a conversion circuit unit converting a wireless power alternating current (AC) signal into half-cycle input signals V_{INN} and V_{INP}; and an output generation circuit unit generating a plurality of outputs within a half cycle by generating a plurality of gate signals in a plurality of different regions within each half cycle based on the half-cycle input signal V_{INN} input through the conversion circuit unit.

The conversion circuit unit may include: a resonant circuit unit L₂C₂ receiving the wireless power AC signal; and a pair of transistors N₁ and N₂ connected to the resonant circuit unit L₂C₂ in parallel and cross-coupled, wherein the pair of transistors N₁ and N₂ cross-coupled may convert the wireless power AC signal input through the resonant circuit unit L₂C₂ into the half-cycle input signals V_{INN} and V_{INP}.

The output generation circuit unit may include: a first output circuit unit generating a first reference signal V_{REF,PL} using a signal output through the conversion circuit unit in a first region, and generating a first gate signal V_{G,PL} using the half-cycle input signal V_{INN} and the first reference signal V_{REF,PL}; a second output circuit unit generating a second reference signal V_{REF,PC} using a signal output through the conversion circuit unit in a second region, and generating a second gate signal V_{G,PC} using the half-cycle input signal VIN and the second reference signal V_{REF,PC}; and a third output circuit unit generating a third reference signal V_{REF,PR} using a signal output through the conversion circuit unit in a third region, and generating a third gate signal V_{G,PR} using the half-cycle input signal V_{INN} and the third reference signal V_{REF,PR}.

The second region is a peak center region of the half cycle, the first region is any region on a left side of the peak center region, and the third region is any region on a right side of the peak center region.

Each of the first, second, and third output circuit units may include: a transistor; a reference signal generation unit receiving a signal output from the conversion circuit unit through the transistor and generating a target reference signal; and a total comparator generating a target gate signal using the half-cycle input signal V_{INN} and the target reference signal, wherein the target gate signal may adjust the target reference signal to be equal to a target voltage, a source of the transistor may be connected to the conversion circuit unit and receive the half-cycle input signal V_{INN}, a gate of the transistor may be connected to an output terminal of the total comparator, and a drain of the transistor may be connected to an output terminal of the reference signal generation unit, the target reference signal may be any one of the first reference signal V_{REF,PL} the second reference signal V_{REF,PC}, and the third reference signal V_{REF,PR}, and the target gate signal may be any one of the first gate signal V_{G,PL}, the second gate signal V_{G,PC}, and the third gate signal V_{G,PC}.

The total comparator included in the first output circuit unit may include: a comparator sensing a first point in time at which the half-cycle input signal V_{INN} and the first reference signal become equal to each other and outputting a comparator output signal V_{CMP,PL}; a pulse width modulation (PWM) controller comparing the first reference signal V_{REF,PL} with a target voltage V_{TG,PL} to determine a delay of the comparator output signal V_{CMP,PL}, determining a second point in time t_{P,PL} of the first gate signal V_{G,PL}, and adjusting the first reference signal V_{REF,PL} to match with the target voltage V_{TG,PL}; and a driving circuit unit outputting a first gate signal that falls at the first point in time t_{S,PL} and rises at the second point in time t_{S,PL}.

The total comparator included in the second output circuit unit may include: a comparator sensing each of a third point in time t_{S,PC} and a fourth point in time t_{E,PC} at which the half-cycle input signal V_{INN} and the second reference signal V_{REF,PC} become equal to each other and generating a comparator output signal V_{CMP,PC}, the comparator output signal V_{CMP,PC} falling at the third point in time t_{S,PC} and rising at the fourth point in time t_{E,PC}; a PWM controller comparing the second reference signal V_{REF,PC} with a target voltage V_{TG,PC} to determine a delay of the comparator output signal V_{CMP,PC}, determining a fifth point in time t_{P,PC} for matching the second reference signal V_{REF,PC} with the target voltage V_{TG,PC}, and generating an output signal V_{P,PC} that falls at the fifth point in time t_{P,PC}; and a driving circuit unit receiving the comparator output signal V_{CMP,PC} and the output signal V_{P,PC} of the PWM controller and generating a second gate signal V_{G,PC} that falls at the third point in time t_{S,PL} and rises at the fifth point in time t_{P,PC}.

The total comparator included in the third output circuit unit may include: a comparator sensing a sixth point in time t_{E,PR} at which the half-cycle input signal V_{INN} and the third reference signal V_{REF,PR} become equal to each other and generating a comparator output signal V_{CMP,PR}; a PWM controller comparing the third reference signal V_{REF,PR} with a target voltage V_{TG,PR} to determine a delay of the comparator output signal V_{CMP,PC}, determining a seventh point in time t_{P,PR} at which the third gate signal V_{G,PR} falls, and generating an output signal V_{P,PR} adjusting the third reference signal V_{REF,PR} to match with the target voltage V_{TG,PR}; and a driving circuit unit generating a third gate signal V_{G,PR} that falls at the seventh point in time t_{P,PR} and rises at the sixth point in time t_{E,PR}.

The PWM controller may include: an OTA circuit unit receiving the third reference signal V_{REF,PR} and the target voltage V_{TG,PR} and generating an output current signal V_{OTA}; a multiplexer M₅ receiving a threshold voltage and the output current signal V_{OTA} of the OTA circuit unit and then outputting any one of the threshold voltage and the output current signal V_{OTA}; a bias determination circuit unit N₁₇ having a gate connected to an output of the multiplexer M₅, and determining a bias current by setting a bias by the output current signal V_{OTA} output through the multiplexer M₅; and a current control pulse delay circuit unit delaying the comparator output signal V_{CMP,PR} based on the bias current to generate the output signal V_{P,PR} adjusting the third reference signal V_{REF,PR} to match with the target voltage V_{TG,PR}, wherein the output current signal V_{OTA} may increase when the third reference signal V_{REF,PR} exceeds the target voltage V_{TG,PR}.

When a selection signal S_{PR,PRE} of the multiplexer M₅ is “0”, the bias determination circuit unit N₁₇ may be biased to the threshold voltage higher than a cut-off mode.

The driving circuit unit may include a negative threshold gate driving circuit unit setting the third gate signal V_{G,PR} to a negative threshold voltage −V_{TH} by charging a capacitor C₃ to a threshold voltage V_{TH} through a charging path according to the second reference signal V_{REF_PC} when the third gate signal V_{G,PR} rises and discharging the capacitor C₃ through a discharging path when the third gate signal V_{G,PR} falls, in generating the third gate signal V_{G,PR} that falls at the seventh point in time t_{P,PR} and rises at the sixth point in time t_{E,PR}.

The third output circuit unit may set a point where the half-cycle input signal V_{INN} input through the conversion circuit unit coincides with the third reference signal V_{REF,PR} while decreasing as a reference starting point, and then adjust a gate width length in a left direction to generate a third gate signal V_{G,PR}.

The total comparator included in the third output circuit unit may further include a bridge circuit unit having an SR latch circuit unit, and receiving the comparator output signal V_{CMP,PR} at an R-input terminal and receiving an end protection control signal at an S-input terminal and then generating an output signal V_{Q,PR} that falls at the end protection signal and rises at the seventh point in time, and the PWM controller may delay the output signal V_{Q,PR} of the bridge circuit unit to generate the output signal V_{P,PR} that falls at the seventh point in time.

The PWM controller may receive the third reference signal V_{REF,PR} through a positive input terminal and the target voltage V_{TG,PR} through a negative input terminal in a crossed structure.

By providing the single-input multi-output resonant regulating rectifier according to an embodiment of the present disclosure, three outputs may be generated within the half cycle.

In addition, the present disclosure may have a low output voltage ripple and high maximum output power, may be capable of selecting a multiple output mode, and may be applied to medical system on chips (SoCs) or artificial retinas requiring dynamic voltage scaling through three output modes.

In addition, the present disclosure may lower a gate voltage to −Vth when generating a low output voltage, and accordingly, allow a system to have high efficiency when generating three outputs.

### BRIEF DESCRIPTION OF DRAWINGS

FIGS. 1 to 4 are diagrams illustrated for describing resonant regulating rectifiers according to the related art.

FIG. 5 is a diagram illustrating a structure of a single-input multi-output resonant regulating rectifier according to an embodiment of the present disclosure.

FIG. 6 is a detailed circuit diagram of a first total comparator according to an embodiment of the present disclosure.

FIG. 7 is a detailed circuit diagram of a second total comparator according to an embodiment of the present disclosure.

FIG. 8 is a detailed circuit diagram of a third total comparator according to an embodiment of the present disclosure.

FIG. 9 is a detailed circuit diagram of a pulse width modulation (PWM) controller according to an embodiment of the present disclosure.

FIGS. 10 and 11 are diagrams illustrated for describing reverse control according to an embodiment of the present disclosure.

FIG. 12 is a detailed circuit diagram of a driving circuit unit and a bridge circuit unit according to an embodiment of the present disclosure.

FIG. 13 is a detailed circuit diagram of a negative threshold gate driving circuit unit according to an embodiment of the present disclosure.

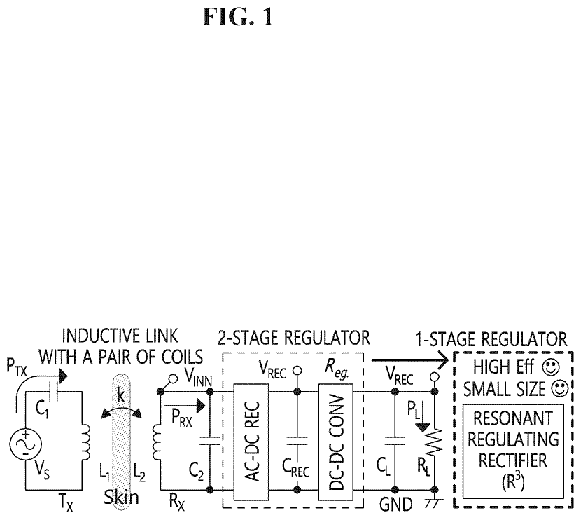

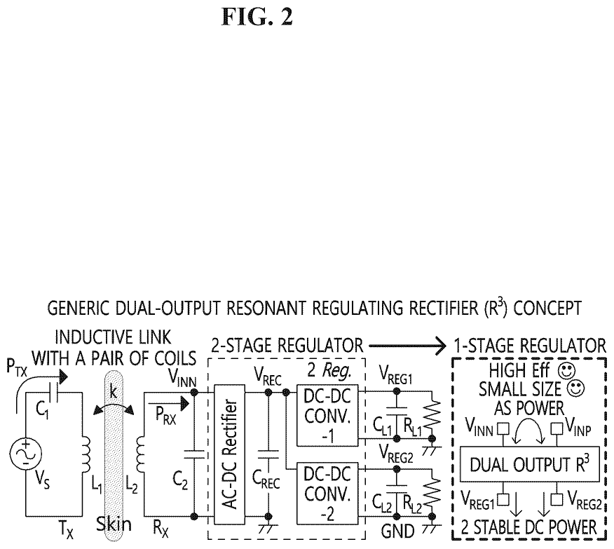

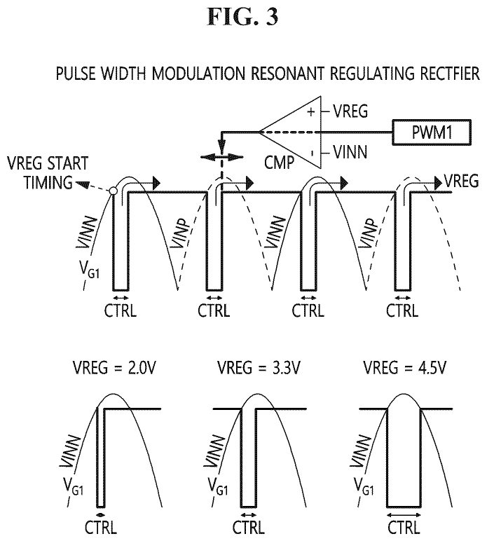

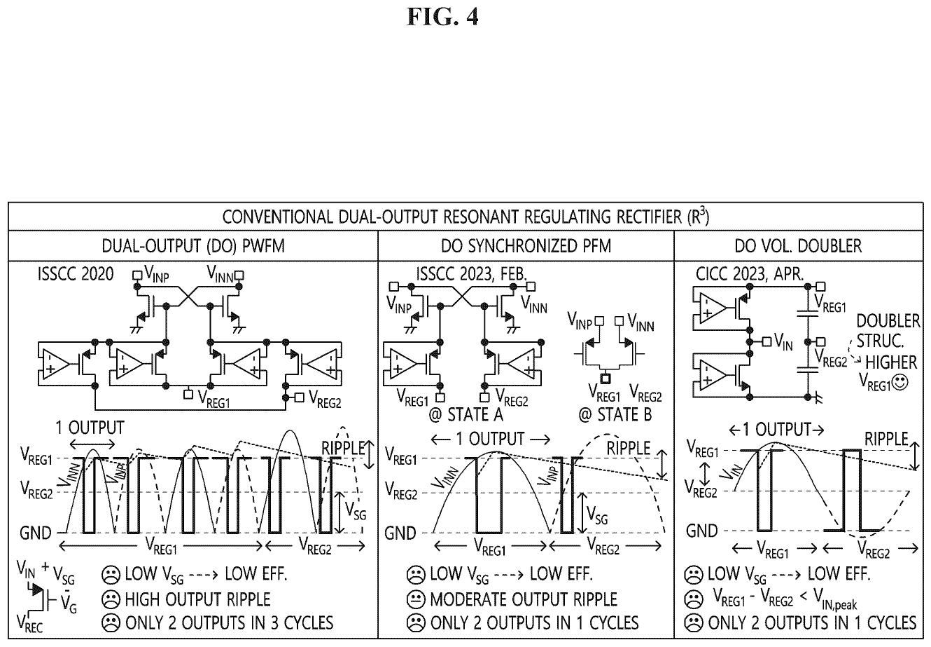

### DETAILED DESCRIPTION

Singular forms as used in this specification include plural forms unless the context clearly indicates otherwise. The term “composed of”, “include”, or the like, as used herein is not to be construed as necessarily including all of several components or several steps described herein, and it is to be construed that some of these components or steps may not be included or additional components or steps may be further included. In addition, the terms “ . . . unit”, “module”, and the like, as used herein refer to a processing unit of at least one function or operation and may be implemented as hardware or software or a combination of hardware and software.

Hereinafter, embodiments of the present disclosure will be described in detail with reference to the accompanying drawings.

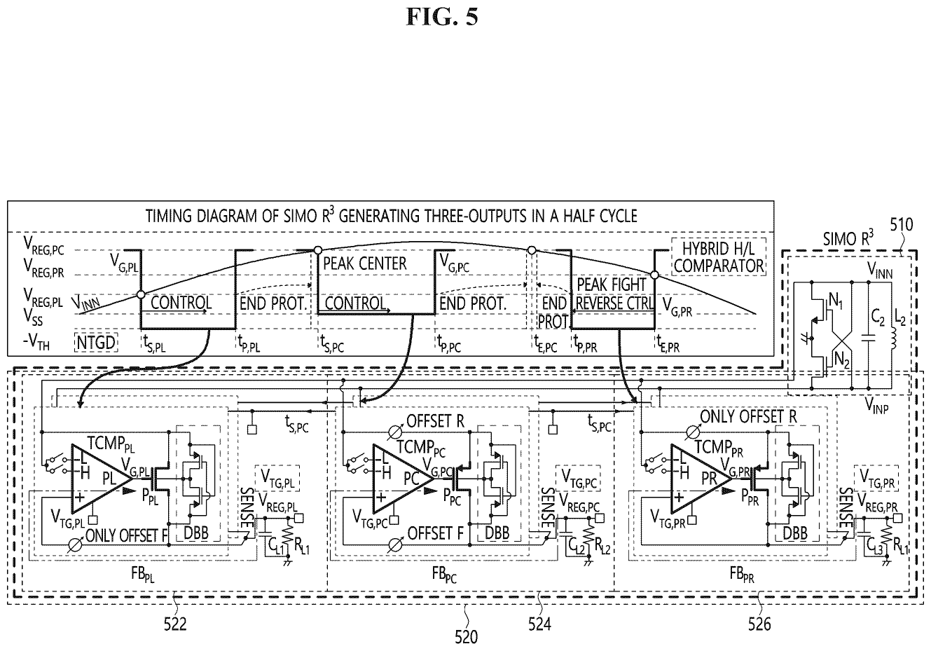

FIG. 5 is a diagram illustrating a structure of a single-input multi-output resonant regulating rectifier according to an embodiment of the present disclosure.

Referring to FIG. 5, the single-input multi-output resonant regulating rectifier according to an embodiment of the present disclosure is configured to include a conversion circuit unit 510 and an output generation circuit unit 520.

The conversion circuit unit 510 is configured to include a resonant circuit unit L₂C₂ and a pair of transistors N₁ and N₂ connected to the resonant circuit unit L₂C₂ in parallel and cross-coupled.

Wireless power AC transmitted from a transmitting end may be input to the resonant circuit unit L₂C₂. Accordingly, when the wireless power AC is input to the resonant circuit unit L₂C₂, the wireless power AC may be converted into half-cycle input signals V_{INN} and V_{INP} by the pair of transistors N₁ and N₂ connected to the resonant circuit unit L₂C₂ in parallel and cross-coupled.

When the wireless power AC is input to the conversion circuit unit 510, the conversion circuit unit 510 may convert the wireless power AC into a half-cycle input signal V_{INN} and output the half-cycle input signal V_{INN}, and the half-cycle input signal V_{INN} may be converted as illustrated in FIG. 5 according to the wireless power AC.

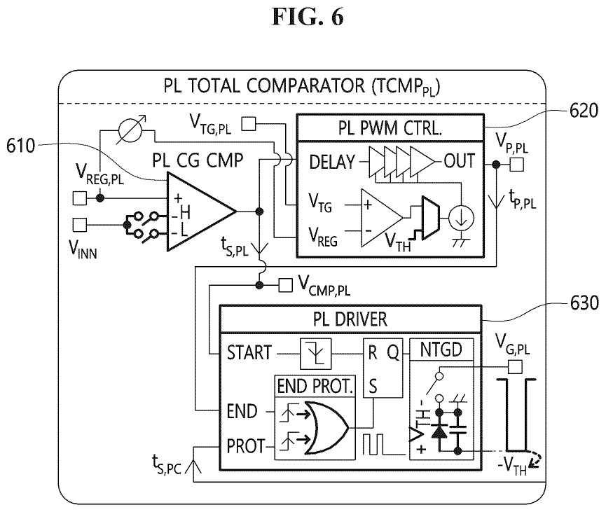

The single-input multi-output resonant regulating rectifier according to an embodiment of the present disclosure may generate three output signals within a half-cycle input signal as illustrated in FIG. 6.

To this end, the single-input multi-output resonant regulating rectifier may generate three outputs by generating gate signals at three preset points within a half cycle in order to generate three outputs within the half-cycle input signal.

According to an embodiment of the present disclosure, the single-input multi-output resonant regulating rectifier may generate three outputs within the half cycle by generating gate signals in a peak center region (hereinafter referred to as a PC region), a left region (hereinafter referred to as a PL region) of the peak center region, and a right region (hereinafter referred to as a PR region) of the peak center region in the half-cycle input signal V_{INN}.

The output generation circuit unit 520 is a signal generation circuit unit for generating a plurality of gate signals in a plurality of different regions (i.e., the PL region, the PC region, and the PR region) within the half cycle based on the half-cycle input signal V_{INN} input through the conversion circuit unit 510.

That is, the output generation circuit unit 520 according to an embodiment of the present disclosure may generate three gate signals within the half cycle to generate three outputs. This will be more clearly understood by the following description.

The output generation circuit unit 520 is configured to include a first output circuit unit 522, a second output circuit unit 524, and a third output circuit unit 526.

The first output circuit unit 522 is a means for generating a first reference signal V_{REF,PL} using a signal input through the resonant circuit unit L₂C₂ in the PL region (a first region) and generating a first gate signal V_{G,PL} using the half-cycle input signal V_{INN} and the first reference signal V_{REF,PL}.

The first output circuit unit 522 is configured to include a first signal generation circuit unit P_{PL} and a first total comparator 522a.

The first signal generation circuit unit PPI may generate a first reference signal V_{REF,PL} by transferring power input through the resonant circuit unit L₂C₂ in the PL region of the half-cycle input signal V_{INN} to a first reference signal generation circuit unit C_{L1}R_{L1}.

Here, the first signal generation circuit unit P_{PL} may be implemented as a P-channel metal oxide semiconductor (PMOS). That is, a source of the first signal generation circuit unit P_{PL} may be connected to one component of the conversion circuit unit to receive an output from the resonant circuit unit L₂C₂, and a gate of the first signal generation circuit unit PPI may be connected to an output terminal of the first total comparator 522a to receive the first gate signal V_{G,PL}. In addition, a drain of the first signal generation circuit unit PPI, may be connected to one end of the first reference signal generation circuit unit C_{L1}R_{L1}.

The first total comparator 522a may generate the first gate signal V_{G,PL} based on the half-cycle input signal V_{INN} transferred from the conversion circuit unit 510 and the first reference signal fed back from the first reference signal generation circuit unit C_{L1}R_{L1}. The first gate signal V_{G,PL} may adjust the first reference signal V_{REF,PL} to be equal to a target voltage V_{TG,PL}.

The first total comparator 522a may sense a first point in time t_{S,PL} at which the half-cycle input signal V_{INN} and the first reference signal V_{REF,PL} become equal to each other, determine a second point in time t_{P,PL} so that the first reference signal V_{REF,PL} coincides with the target voltage V_{TG,PL}, and output the first gate signal V_{G,PL} that falls at the first point in time t_{S,PL} and rises at the second point in time t_{P,PL}.

Even though t_{S,PL} is described as the first point in time in a context in the present specification, the first point in time may generate a first synchronization signal. Accordingly, even though t_{S,PL} is described as the first point in time in the context, it should be widely construed to include the first synchronization signal, and this should also be widely construed at each point in time.

A detailed circuit diagram of the first total comparator 522a is illustrated in FIG. 6.

Referring to FIG. 6, the first total comparator 522a is configured to include a comparator 610, a pulse width modulation (PWM) controller 620, and a driving circuit unit 630.

The comparator 610 may sense the first point in time t_{S,PL} at which the half-cycle input signal V_{INN} and the fed-back first reference signal V_{REF,PL} become equal to each other, and output a comparator output signal V_{CMP,PL}. That is, the comparator output signal V_{CMP,PL}, which is an output of the comparator 610, may fall at the first point in time t_{S,PL}, and the first point in time t_{S,PL} at which the half-cycle input signal V_{INN} and the first reference signal V_{REF,PL} become equal to each other may be accurately sensed by applying an offset-controlled front (TCAS-1, 2011) technology.

The PWM controller 620 may compare the first reference signal V_{REF,PL} with the target voltage V_{TG,PL} to determine a delay of the comparator output signal V_{CMP,PL}, and generate an output V_{P,PL} that falls at a second point in time t_{P,PL}.

The driving circuit unit 630 may receive the output V_{P,PL} of the PWM controller 620 and the output (comparator output signal V_{CMP,PL}) of the comparator 610 and generate the first gate signal V_{G,PL} that falls at a first point in time t_{S,PL} and rises at a second point in time t_{P,PL}.

In addition, the driving circuit unit 630 includes a negative threshold gate driving circuit unit NTGD. The first gate signal V_{G,PL} may be set to a negative threshold voltage −V_{TH} instead of a ground GND by using the negative threshold gate driving circuit unit NTGD. This will be described in more detail below.

As described above, in the first output circuit unit 522, the first reference signal V_{REF,PL} may be adjusted to be equal to the target voltage V_{TG,PL} through a feedback path composed of the comparator 610, the PWM controller 620, and the driving circuit unit 630.

The second output circuit unit 524 is a means for generating an output signal in a second region (PC region) of the half-cycle input signal V_{INN}.

The second output circuit unit 524 may generate a second reference signal V_{REF,PC} using a signal output through the conversion circuit unit 510, and may generate a second gate signal V_{G,PC} using the half-cycle input signal V_{INN} and the second reference signal V_{REF,PC}.

This will be described in more detail.

The second output circuit unit 524 is configured to include a second signal generation circuit unit P_{PC} and a second total comparator 524a.

The second signal generation circuit unit P_{PC} may generate a second reference signal V_{REF,PC} by transferring power input through the resonant circuit unit L₂C₂ in the PC region of the half-cycle input signal V_{INN} to a second reference signal generation circuit unit C_{L2}R_{L2}.

The second total comparator 524a may generate the second gate signal V_{G,PC} based on the half-cycle input signal V_{INN} transferred from the conversion circuit unit 510 and the second reference signal V_{REF,PC} fed back from the second reference signal generation circuit unit C_{L2}R_{L2}. The second gate signal V_{G,PC} may adjust a target voltage V_{TG,PC} to be equal to the second reference signal V_{REF,PC}.

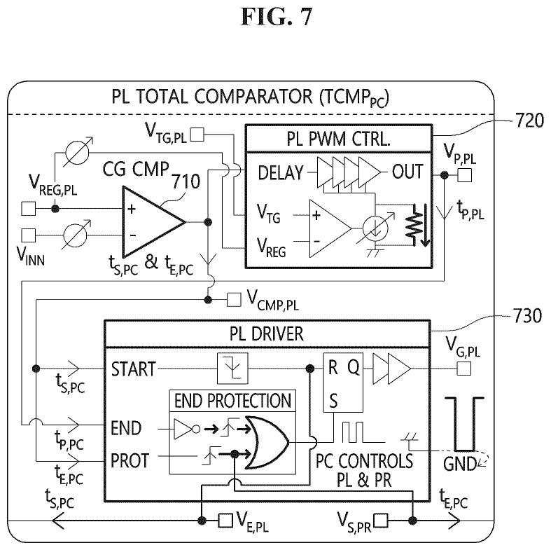

A detailed circuit diagram of the second total comparator 524a is illustrated in FIG. 7.

Referring to FIG. 7, the second total comparator 524a is configured to include a comparator 710, a PWM controller 720, and a driving circuit unit 730.

The comparator 710 may receive the second reference signal V_{REF,PC} at a first input terminal (+ terminal), receive the half-cycle input signal V_{INN} at a second input terminal (− terminal), and may then sense a third point in time t_{S,PC} and a fourth point in time t_{E,PC} at which the half-cycle input signal V_{INN} becomes identical to the second reference signal V_{REF,PC}.

An output signal V_{CMP,PC} of the comparator 710 may fall at the third point in time t_{S,PC} and rise at the fourth point in time t_{E,PC}.

The PWM controller 720 may receive the second reference signal V_{REF,PC}, the target voltage V_{TG,PC}, and the comparator output signal V_{CMP,PC}, and then may compare the second reference signal V_{REF,PC} with the target voltage V_{TG,PC} to determine a delay of the comparator output signal V_{CMP,PC} and generate an output V_{P,PC} that falls at a fifth point in time t_{P,PL}.

The driving circuit unit 730 may receive the comparator output signal V_{CMP,PC} and the output V_{P,PC} of the PWM controller 720, and then generate the second gate signal V_{G,PC} that falls at a third point in time t_{S,PC} and rises at a fifth point in time t_{P,PL}.

In addition, the driving circuit unit 730 may limit the fifth point in time t_{P,PL} to the fourth point in time t_{E,PC}, generate a first end-protection signal V_{E,PL} rising at the third point in time t_{S,PC}, and generate a second end-protection signal V_{S,PR} rising at the fourth point in time t_{E,PC}.

Here, the first end-protection signal V_{E,PL} may operate as an end point protection signal of the first total comparator 522a, and the second end-protection signal V_{S,PR} may operate as an end point protection signal of the third total comparator 526a. Through this, the second reference signal V_{REF,PC} may be regulated to the target voltage V_{TG,PC}.

The third output circuit unit 526 is a means for generating an output in the PR region (third region).

That is, the third output circuit unit 526 may generate a third reference signal V_{REF,PR} using a signal output through the conversion circuit unit 510 in the third region, and may generate a third gate signal V_{G,PR} using the half-cycle input signal V_{INN} and the third reference signal V_{REF,PR}.

The third output circuit unit 526 is configured to include a third signal generation circuit unit P_{PR} and a third total comparator 526a.

The third signal generation circuit unit P_{PR} may generate a third reference signal V_{REG,PR} by transferring power input through the resonant circuit unit L₂C₂ in the PR region of the half-cycle input signal V_{INN} to a third reference signal generation circuit unit C_{L3}R_{L3}.

The third total comparator 526a may generate the third gate signal V_{G,PR} based on the half-cycle input signal V_{INN} transferred from the conversion circuit unit 510 and the third reference signal V_{REF,PR} fed back from the third reference signal generation circuit unit C_{L3}R_{L3}. The third gate signal V_{G,PR} may adjust the third reference signal V_{REF,PR} to be equal to a target voltage V_{TG,PR}.

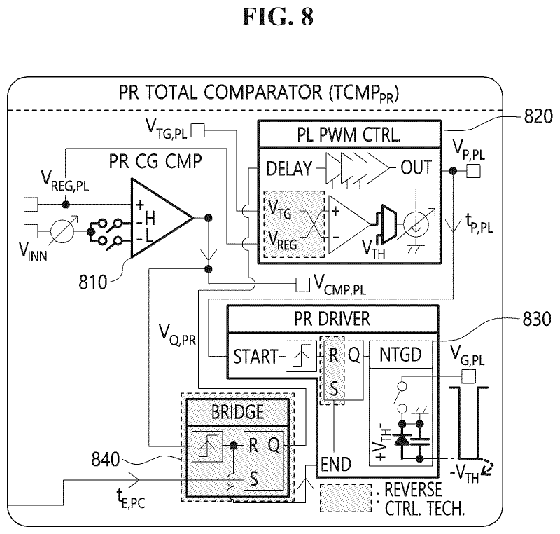

More specifically, as illustrated in FIG. 8, the third total comparator 526a is configured to include a comparator 810, a PWM controller 820, and a driving circuit unit 830.

The comparator 810 may receive the third reference signal V_{REF,PR} and the half-cycle input signal V_{INN}, and then widely and accurately sense a rise time of the third gate signal V_{G,PR}. To this end, the comparator 810 may sense a sixth point in time t_{E,PR} at which the half-cycle input signal V_{INN} and the third reference signal V_{REF,PR} become equal to each other, and generate a comparator output signal V_{CMP,PR}.

The PWM controller 820 may compare the third reference signal V_{REF,PR} with the target voltage V_{TG,PR} to determine a delay of the comparator output signal V_{CMP,PR}, determine a seventh point in time t_{P,PR} at which the third gate signal V_{G,PR} falls, and generate an output signal V_{P,PR} adjusting the third reference signal V_{REF,PR} to match with the target voltage V_{TG,PR}. Here, the seventh point in time t_{P,PR} may be limited by the fourth point in time t_{E,PC} (more specifically, the second end-protection signal V_{S,PR}) provided from the second total comparator 524a.

In addition, the PWM controller 820 may receive the target voltage V_{TG,PR} and the third reference signal V_{REF,PR} input in a crossed structure compared to the first total comparator 522a and the second total comparator 524a in order to implement reverse control.

For example, a comparator 610 inside the PWM controller 620 of the first total comparator 522a may receive the target voltage V_{TG,PL} at a + input terminal, and receive the third reference signal V_{REF,PR} at a-input terminal. On the other hand, a comparator 810 inside the PWM controller 820 may receive the target voltage V_{TG,PR} at a-input terminal and the third reference signal V_{REF,PR} at a + input terminal in a crossed structure in order to implement the reverse control.

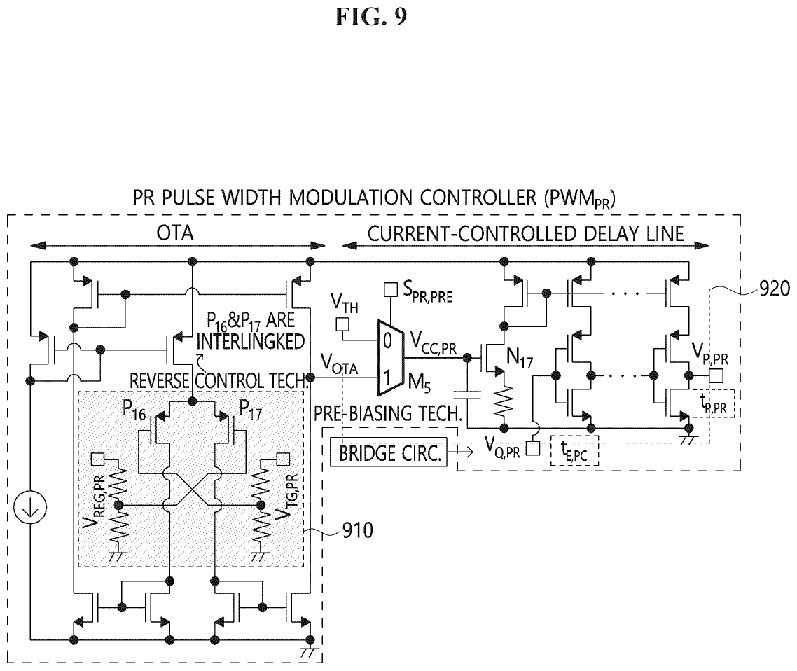

A detailed circuit diagram of the PWM controller 820 is illustrated in FIG. 9.

Referring to FIG. 9, an operation of the PWM controller 820 will be described in more detail.

The PWM controller 820 may determine the seventh point in time t_{P,PR}, which is a pulse width falling point in time of the third gate signal V_{G,PR}, and adjust the third reference signal V_{REF,PR} to match with the target voltage V_{TG,PR}.

Referring to FIG. 9, the PWM controller 820 is configured to include an OTA circuit unit 910 and a current control delay circuit unit 920.

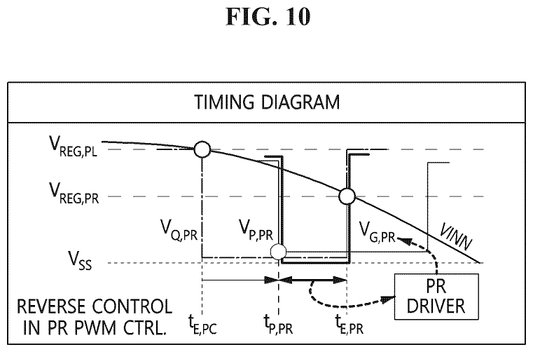

The OTA circuit unit 910 receives the target voltage V_{TG,PR} and the third reference signal V_{REF,PR} using a transistor P₁₆ and a transistor P₁₇ and generates an output V_{OTA}. As illustrated in FIG. 10, unlike the PWM controller 620 and the PWM controller 720 of the first and second total comparators 522a and 524a, the target voltage V_{TG,PR} and the third reference signal V_{REF,PR} may be cross-connected in order to implement the reverse control. For this reason, when the third reference signal V_{REF,PR} exceeds the target voltage V_{TG,PR}, the output V_{OTA} of the OTA circuit unit 910 increases.

The output V_{OTA} of the OTA circuit unit 910 is input to a multiplexer M₅ inside the current control delay circuit unit 920. An output terminal V_{CC,PR} of the multiplexer M₅ is connected to a gate of the transistor N₁₇. For this reason, when a selection signal S_{PR,PRE} of the multiplexer M₅ is 1, a bias of the gate of the transistor N₁₇ may be set by the output V_{OTA} of the OTA circuit unit 910 to determine a bias current of the current control delay circuit unit 920 and adjust the third reference signal V_{REF,PR} to match with the target voltage V_{TG,PR}.

In addition, the current control delay circuit unit 920 may delay an output signal V_{Q,PR} of a bridge circuit unit 840 to generate an output V_{P,PR} that falls at the seventh point in time t_{P,PR}.

The fourth point in time t_{E,PC}, which is a falling point in time of the output signal V_{Q,PR} of the bridge circuit unit 840, more specifically, the second end-protection signal V_{S,PR} may be delayed to the seventh point in time t_{P,PR}, which is a falling point in time of an output signal V_{P,PR} of the current control delay circuit unit 920 (see FIG. 10).

The driving circuit unit 830 may generate the third gate signal V_{G,PR} that falls at the seventh point in time t_{P,PR} and rises at the sixth point in time t_{E,PR}.

That is, the third total comparator 526a may implement the reverse control in a manner of delaying the fourth point in time t_{E,PC} to the seventh point in time t_{P,PR} and subtracting the fourth point in time t_{E,PC} from the seventh point in time t_{P,PR}.

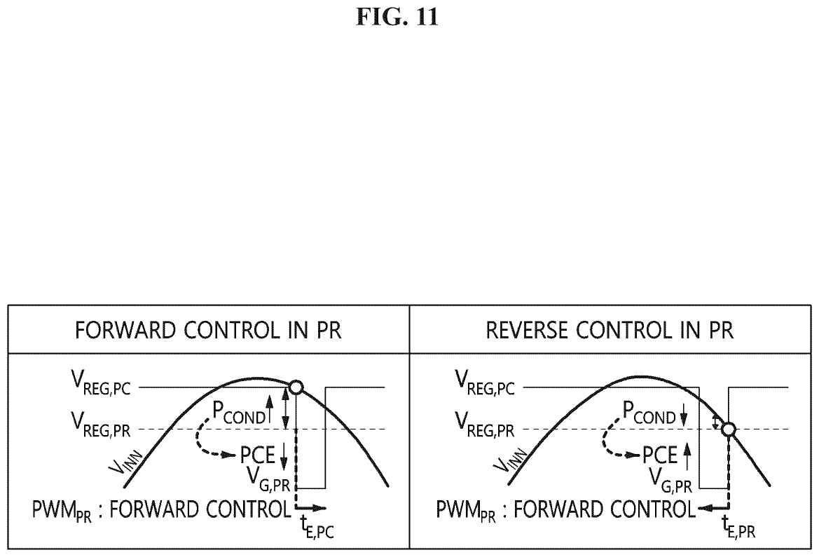

This will be described in more detail with reference to FIG. 11.

As illustrated in FIG. 11, when forward control is implemented in the third total comparator 526a, the PWM controller 820 determines a width of the third gate signal V_{G,PR} from the fourth point in time t_{E,PC}. However, this has a disadvantage that high conduction loss is caused in the third signal generation circuit unit P_{PR} due to a great difference between the half-cycle input signal V_{INN} and the third reference signal V_{REF,PR}, which results in a decrease in power conversion efficiency (PCE).

However, as in an embodiment of the present disclosure, through the reverse control, the PWM controller 820 may determine a width of the third reference signal V_{REF,PR} from the sixth point in time t_{E,PR} and reduce a gap between the half-cycle input signal V_{INN} and the third reference signal V_{REF,PR} to increase the power conversion efficiency.

In addition, the third total comparator 526a may bias the transistor N₁₇ to be slightly higher than a cut-off mode by setting an output signal V_{CC,PR} of the multiplexer M₅ to a threshold voltage V_{TH} when the selection signal S_{PR,PRE} of the multiplexer M₅ is 0. For this reason, when the selection signal S_{PR,PRE} of the multiplexer M₅ changes to 1, the S_{PR,PRE} of the multiplexer M₅ may be smoothly switched in a process of changing to the output signal V_{OTA} of the OTA circuit unit 910.

The driving circuit unit 830 also requires cross-connection in order to implement reverse control. The driving circuit unit 830 generate the third gate signal V_{G,PR} that falls at the seventh point in time t_{P,PR} and rises at the sixth point in time t_{E,PR}.

The driving circuit unit 830 may have a negative threshold gate driving circuit unit NTGD, and the third gate signal V_{G,PR} may be lowered below a negative threshold voltage −V_{TH} by the negative threshold gate driving circuit unit NTGD.

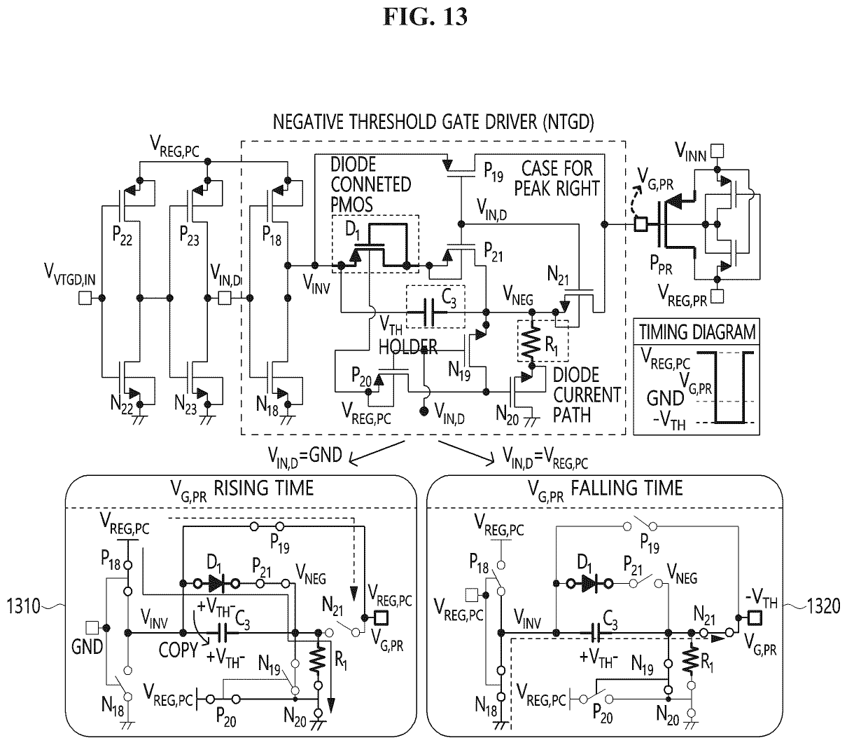

Referring to FIG. 13, when an initial gate signal (e.g., V_{G,PR}) rises, an output line of the third gate signal V_{G,PR} may be connected to an input line of the second reference signal V_{REG,PC} as represented by reference number 1310. For this reason, a transistor P_{PR} may be set to a turn-off state.

An input terminal of the second reference signal V_{REF,PC} is connected to a source terminal of a transistor P₁₈, the transistor P₁₈ is turned on by the second reference signal V_{REF,PC}, the second reference signal V_{REF,PC} is transferred to a first diode D₁ through a V_{INV} contact node connected to a drain terminal of the transistor P₁₈, a transistor P₂₁ having a source terminal connected to an output terminal of the first diode D₁ is turned on, and the second reference signal V_{REF,PC} is transferred to a ground through a resistor R₁ having one end connected to a VNEG contact node through a drain terminal of the transistor P₂₁.

In addition, a threshold voltage V_{TH} of the first diode D₁ is copied from the V_{INV} contact node to a capacitor C₃ connected to the first diode D₁ in parallel, such that the capacitor C₃ is charged to a threshold voltage level.

In other words, when the initial third gate signal V_{G,PR} rises, the second reference signal V_{REF,PC} flows to a ground through a first path to the transistor P₁₈, the first diode D₁, the transistor P₂₁, and the resistor R₁, and through this process, the capacitor C₃ connected to the first diode D₁ in parallel is charged to the threshold voltage V_{TH} level.

On the other hand, when the third gate signal V_{G,PR} falls, the transistor P₁₈ is turned off and the transistor P₂₁ is also turned off, a transistor N₁₈ is turned on, a transistor N₂₁ to which the other end of the capacitor C₃ is connected is turned on, and the capacitor C₃ is discharged, such that the third gate signal V_{G,PR} may be set to a negative threshold voltage-V_{TH}.

In other words, when the third gate signal V_{G,PR} falls, the capacitor C₃ is discharged through a second path 1320 (see FIG. 13) to the transistor N₁₈, the capacitor C₃, and the transistor N₂₁, such that the third gate signal V_{G,PR} may be set to a negative threshold voltage −V_{TH}. Through this, the third gate signal V_{G,PR} may be set between the second reference signal V_{REF,PC} and the negative threshold voltage −V_{TH}.

A feedback circuit unit of the third total comparator 526a is composed of the comparator 810, the PWM controller 820, and the driving circuit unit 830, through which the third reference signal V_{REF,PR} may be adjusted to be equal to the target voltage V_{TG,PR}.

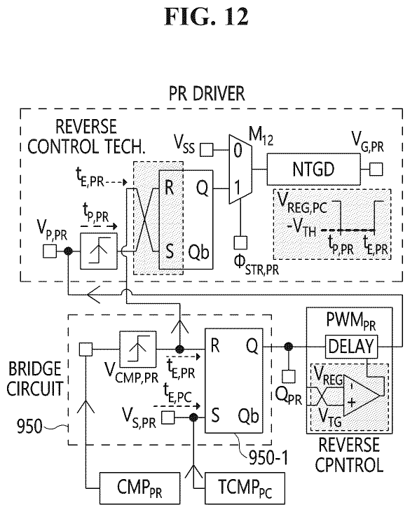

A circuit diagram of the driving circuit unit 830 and a circuit diagram of the bridge circuit unit 840 are illustrated in FIG. 12.

The bridge circuit unit 840 is composed of an SR latch circuit unit 840-1. The SR latch circuit unit 840-1 may receive the comparator output signal V_{CMP,PR} provided from the third total comparator 526a at an R-input terminal, receive the second end-protection signal V_{S,PR} provided from the second total comparator 524a at an S-input terminal, and then may generate an output signal V_{Q,PR} that falls at the fourth point in time t_{E,PC} and rises at the seventh point in time t_{P,PR}.

Subsequently, the output signal V_{Q,PR} of the bridge circuit unit 840 may pass through the PWM controller 820 and be used to generate an output signal V_{P,PR} of the PWM controller 820 that falls at the seventh point in time t_{P,PR}.

The embodiments of the present disclosure have been mainly described hereinabove. It will be understood by those skilled in the art to which the present disclosure pertains that the present disclosure may be implemented in a modified form without departing from essential characteristics of the present disclosure. Therefore, the embodiments disclosed herein should be considered in an illustrative aspect rather than a restrictive aspect. The scope of the present disclosure should be defined by the claims rather than the above description, and all differences within the scope equivalent to the claims should be interpreted to fall within the present disclosure.

What is claimed is:

1. A single-input multi-output resonant regulating rectifier, comprising:
a conversion circuit unit converting a wireless power alternating current (AC) signal into half-cycle input signals V_{INN} and V_{INP}; and
an output generation circuit unit generating a plurality of outputs within a half cycle by generating a plurality of gate signals in a plurality of different regions within each half cycle based on the half-cycle input signal V_{INN} input through the conversion circuit unit.

2. The single-input multi-output resonant regulating rectifier of claim 1, wherein the conversion circuit unit includes:
a resonant circuit unit L₂C₂ receiving the wireless power AC signal; and
a pair of transistors N₁ and N₂ connected to the resonant circuit unit L₂C₂ in parallel and cross-coupled,
wherein the pair of transistors N₁ and N₂ cross-coupled converts the wireless power AC signal input through the resonant circuit unit L₂C₂ into the half-cycle input signals V_{INN} and V_{INP}.

3. The single-input multi-output resonant regulating rectifier of claim 1, wherein the output generation circuit unit includes:
a first output circuit unit generating a first reference signal V_{REF,PL} using a signal output through the conversion circuit unit in a first region, and generating a first gate signal V_{G,PL} using the half-cycle input signal V_{INN} and the first reference signal V_{REF,PL};
a second output circuit unit generating a second reference signal V_{REF,PC} using a signal output through the conversion circuit unit in a second region, and generating a second gate signal V_{G,PC} using the half-cycle input signal V_{INN} and the second reference signal V_{REF,PC}; and
a third output circuit unit generating a third reference signal V_{REF,PR} using a signal output through the conversion circuit unit in a third region, and generating a third gate signal V_{G,PR} using the half-cycle input signal V_{INN} and the third reference signal V_{REF,PR}.

4. The single-input multi-output resonant regulating rectifier of claim 3, wherein the second region is a peak center region of the half cycle,
the first region is any region on a left side of the peak center region, and
the third region is any region on a right side of the peak center region.

5. The single-input multi-output resonant regulating rectifier of claim 3, wherein each of the first, second, and third output circuit units includes:
a transistor;
a reference signal generation unit receiving a signal output from the conversion circuit unit through the transistor and generating a target reference signal; and
a total comparator generating a target gate signal using the half-cycle input signal V_{INN} and the target reference signal,
wherein the target gate signal adjusts the target reference signal to be equal to a target voltage,
a source of the transistor is connected to the conversion circuit unit and receives the half-cycle input signal V_{INN}, a gate of the transistor is connected to an output terminal of the total comparator, and a drain of the transistor is connected to an output terminal of the reference signal generation unit,
the target reference signal is any one of the first reference signal V_{REF,PL}, the second reference signal V_{REF,PC}, and the third reference signal V_{REF,PR}, and
the target gate signal is any one of the first gate signal V_{G,PL}, the second gate signal V_{G,PC}, and the third gate signal V_{G,PC}.

6. The single-input multi-output resonant regulating rectifier of claim 5, wherein the total comparator included in the first output circuit unit includes:
a comparator sensing a first point in time at which the half-cycle input signal V_{INN} and the first reference signal become equal to each other and outputting a comparator output signal V_{CMP,PL};
a pulse width modulation (PWM) controller comparing the first reference signal V_{REF,PL} with a target voltage V_{TG,PL} to determine a delay of the comparator output signal V_{CMP,PL}, determining a second point in time t_{P,PL} of the first gate signal V_{G,PL}, and adjusting the first reference signal V_{REF,PL} to match with the target voltage V_{TG,PL}; and
a driving circuit unit outputting a first gate signal that falls at the first point in time t_{S,PL} and rises at the second point in time t_{S,PL}.

7. The single-input multi-output resonant regulating rectifier of claim 5, wherein the total comparator included in the second output circuit unit includes:
a comparator sensing each of a third point in time t_{S,PC} and a fourth point in time t_{E,PC} at which the half-cycle input signal V_{INN} and the second reference signal V_{REF,PC} become equal to each other and generating a comparator output signal V_{CMP,PC}, the comparator output signal V_{CMP,PC} falling at the third point in time t_{S,PC} and rising at the fourth point in time t_{E,PC};
a PWM controller comparing the second reference signal V_{REF,PC} with a target voltage V_{TG,PC} to determine a delay of the comparator output signal V_{CMP,PC}, determining a fifth point in time t_{P,PC} for matching the second reference signal V_{REF,PC} with the target voltage V_{TG,PC}, and generating an output signal V_{P,PC} that falls at the fifth point in time t_{P,PC}; and
a driving circuit unit receiving the comparator output signal V_{CMP,PC} and the output signal V_{P,PC} of the PWM controller and generating a second gate signal V_{G,PC} that falls at the third point in time t_{S,PL} and rises at the fifth point in time t_{P,PC}.

8. The single-input multi-output resonant regulating rectifier of claim 5, wherein the total comparator included in the third output circuit unit includes:
a comparator sensing a sixth point in time t_{E,PR} at which the half-cycle input signal V_{INN} and the third reference signal V_{REF,PR} become equal to each other and generating a comparator output signal V_{CMP,PR};
a PWM controller comparing the third reference signal V_{REF,PR} with a target voltage V_{TG,PR} to determine a delay of the comparator output signal V_{CMP,PC}, determining a seventh point in time t_{P,PR} at which the third gate signal V_{G,PR} falls, and generating an output signal V_{P,PR} adjusting the third reference signal V_{REF,PR} to match with the target voltage V_{TG,PR}; and
a driving circuit unit generating a third gate signal V_{G,PR} that falls at the seventh point in time t_{P,PR} and rises at the sixth point in time t_{E,PR}.

9. The single-input multi-output resonant regulating rectifier of claim 8, wherein the PWM controller includes:
an OTA circuit unit receiving the third reference signal V_{REF,PR} and the target voltage V_{TG,PR} and generating an output current signal V_{OTA};
a multiplexer M₅ receiving a threshold voltage and the output current signal V_{OTA} of the OTA circuit unit and then outputting any one of the threshold voltage and the output current signal V_{OTA};
a bias determination circuit unit N₁₇ having a gate connected to an output of the multiplexer M₅, and determining a bias current by setting a bias by the output current signal V_{OTA} output through the multiplexer M₅; and
a current control pulse delay circuit unit delaying the comparator output signal V_{CMP,PR} based on the bias current to generate the output signal V_{P,PR} adjusting the third reference signal V_{REF,PR} to match with the target voltage V_{TG,PR},
wherein the output current signal V_{OTA} increases when the third reference signal V_{REF,PR} exceeds the target voltage V_{TG,PR}.

10. The single-input multi-output resonant regulating rectifier of claim 9, wherein when a selection signal S_{PR,PRE} of the multiplexer M₅ is “0”, the bias determination circuit unit N₁₇ is biased to the threshold voltage higher than a cut-off mode.

11. The single-input multi-output resonant regulating rectifier of claim 8, wherein the driving circuit unit includes a negative threshold gate driving circuit unit setting the third gate signal V_{G,PR} to a negative threshold voltage-V_{TH} by charging a capacitor C₃ to a threshold voltage V_{TH} through a charging path according to the second reference signal V_{REF,PC} when the third gate signal V_{G,PR} rises and discharging the capacitor C₃ through a discharging path when the third gate signal V_{G,PR} falls, in generating the third gate signal V_{G,PR} that falls at the seventh point in time t_{P,PR} and rises at the sixth point in time t_{E,PR}.

12. The single-input multi-output resonant regulating rectifier of claim 3, wherein the third output circuit unit sets a point where the half-cycle input signal V_{INN} input through the conversion circuit unit coincides with the third reference signal V_{REF,PR} while decreasing as a reference starting point, and then adjusts a gate width length in a left direction to generate a third gate signal V_{G,PR}.

13. The single-input multi-output resonant regulating rectifier of claim 8, wherein the total comparator included in the third output circuit unit further includes a bridge circuit unit having an SR latch circuit unit, and receiving the comparator output signal V_{CMP,PR} at an R-input terminal and receiving an end protection control signal at an S-input terminal and then generating an output signal V_{Q,PR} that falls at the end protection signal and rises at the seventh point in time, and
the PWM controller delays the output signal V_{Q,PR} of the bridge circuit unit to generate the output signal V_{P,PR} that falls at the seventh point in time.

14. The single-input multi-output resonant regulating rectifier of claim 13, wherein the PWM controller receives the third reference signal V_{REF,PR} through a positive input terminal and the target voltage V_{TG,PR} through a negative input terminal in a crossed structure.
